(19) United States
(12) Patent Application Publication
(10) Pub. No.: US 2025/0216736 A1
(43) Pub. Date: Jul. 3, 2025

(54) Conductor for Connecting Multiple Busbars in an Insulated Glazing Unit

(71) Applicant: SAGE Electrochromics, Inc., Faribault, MN (US)

(72) Inventors: Robert J. Anglemier, Waterville, MN (US); Bolei Di, Woodbury, MN (US); Frank McGrogan, Faribault, MN (US)

(73) Assignee: SAGE Electrochromics, Inc., Faribault, MN (US)

(21) Appl. No.: 18/999,856

(22) Filed: Dec. 23, 2024

Related U.S. Application Data
(60) Provisional application No. 63/615,179, filed on Dec. 27, 2023.

(51) Int. Cl. G02F 1/161; G02F 1/155

(52) U.S. Cl. CPC G02F 1/161; G02F 1/155

(57) ABSTRACT

A conductor for an insulated glazing unit (IGU) is described. The IGU may have two or more panes. The two or more panes may run parallel to one another. The IGU May have one or more seals that form a glazing interior space with the first pane and the second pane. The glazing interior space may include one or more recipient devices and multiple busbars. Each of the busbars may be coupled to at least one of the one or more recipient devices. The conductor may include multiple conducting elements that are respectively electrically connected to different ones of the busbars providing power and/or control signals received from a controller for the one or more recipient devices. The conductor may penetrate at least one of the one or more seals at a location where at least two of the busbars are available for connection.

### PRIORITY CLAIM

This application claims benefit of priority to U.S. Provisional Application Ser. No. 63/615,179, entitled “Conductor for Connecting Multiple Busbars in an Insulated Glazing Unit,” filed Dec. 27, 2023, and which is hereby incorporated herein by reference in its entirety.

### FIELD OF THE DISCLOSURE

The present disclosure is directed to conductors electrically connecting controllers to one or more recipient devices in an insulated glazing unit (IGU).

### BACKGROUND

IGUs offer useful features for a variety of different structures and devices. For example, IGUs may implement “smart” glass, which can be used to decrease heat transfer through a window and/or reduce the transmission of visible light to provide tinting or shading. Smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain through a transparent substrate and a reduction in visible light transmission through a transparent substrate (e.g., a window or glass pane).

An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. A controller may be electrically connected to the EC device within the IGU in order to provide electrical power.

### SUMMARY

In some aspects, a system is provided. The system includes an insulated glazing unit (IGU) which includes two or more or panes. The two or more panes may run parallel to one another. The IGU may have one or more seals that form a glazing interior space with the first pane and the second pane. The glazing interior space may include one or more recipient devices and multiple busbars. Each of the busbars may be coupled to at least one of the one or more recipient devices. The IGU may include a conductor, that includes multiple conducting elements. Each conducting element may be respectively electrically connected to different ones of the busbars providing at least one of power and control signal received from a controller for the one or more recipient devices. The conductor may penetrate at least one of the one or more seals at a location where at least two of the busbars are available for connection.

In some aspects, the conductor is directly connected to the controller in an exterior space with respect to the IGU. In some aspects, the conductor is connected via one or more wires to the controller in an exterior space with respect to the IGU.

In some aspects, the conductor includes two or more legs that respectively include a single conducting element and penetrate at least one seal of the IGU. In some aspects, the conductor includes two or more legs that respectively include two or more conducting elements and penetrate at least one seal of the IGU. In some embodiments, the conductor includes a single leg that includes multiple conducting elements and penetrates at least one seal of the IGU.

In some aspects, the conductor includes at least one conducting element that is soldered to at least one a busbar using a pin. In some aspects, the conductor includes at least one conducting element that is soldered to at least one a busbar using a pad. In some aspects, the conductor includes at least one conducting element that is soldered to at least one a busbar using electrically conductive adhesive.

In some aspects, the IGU includes a spacer with contact surfaces that run parallel to one another and connect to respective panes of the IGU via one or more seals.

In some aspects, the conductor is flexible. In some aspects, the conductor is rigid. In some aspects, the conductor is flat with a thickness of less than half of a seal that the conductor penetrates to reach busbars in the interior space of the IGU.

### BRIEF DESCRIPTION OF THE DRAWINGS

FIG. 1A illustrates an insulated glazing unit (IGU) and different views of a conductor that connects a controller to multiple busbars for one or more recipient devices in the IGU, according to some embodiments.

FIG. 1B illustrates a perspective cross-sectional view of an example EC system according to some embodiments.

FIG. 1C illustrates an example recipient device that receives power and/or control signals from a busbar, according to some embodiments.

FIGS. 1D-1E illustrate different example electrical connection elements for conductors, according to some embodiments.

FIG. 2 illustrates an example conductor with a single leg connected to multiple busbars, according to some embodiments.

FIG. 3 illustrates an example conductor with multiple legs connected to individual busbars, according to some embodiments.

FIG. 4 illustrates an example conductor with multiple legs connected to multiple busbars, according to some embodiments.

FIG. 5 illustrates an example conductor with a one leg connected to multiple busbars that meet, according to some embodiments.

FIG. 6 illustrates an example conductor with multiple legs connected to individual busbars using a jump connection, according to some embodiments.

FIG. 7 illustrates an example conductor with multiple legs connected to individual busbars using spaced connections, according to some embodiments.

FIGS. 8A and 8B illustrate different types of connections between controllers for recipient devices in an IGU with a conductor, according to some embodiments.

FIG. 9 illustrates an example computer system that may be used in some embodiments.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may be as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

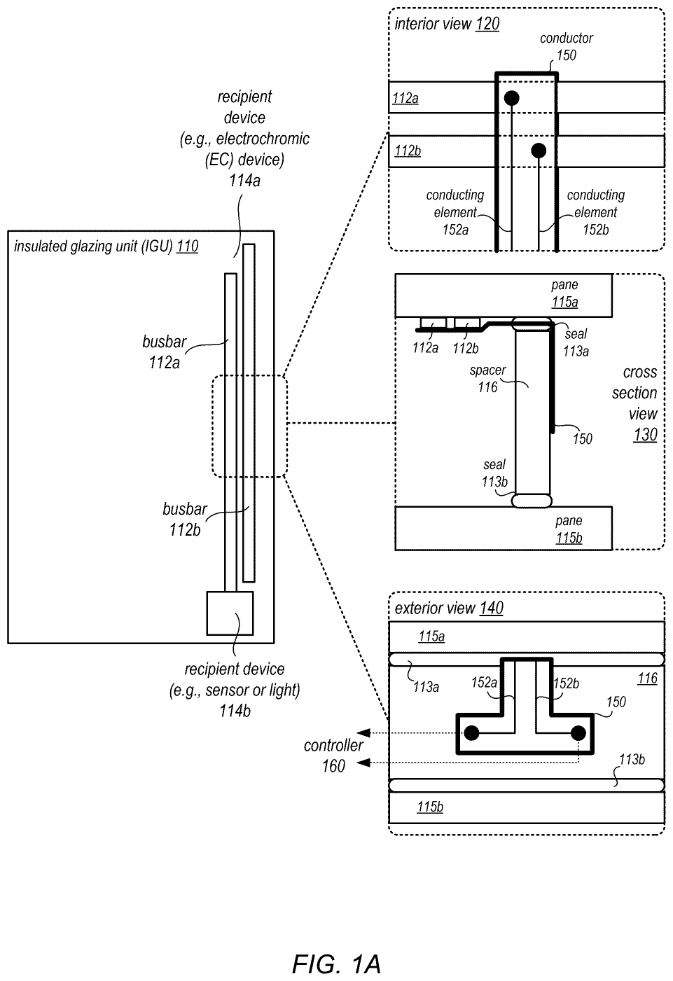

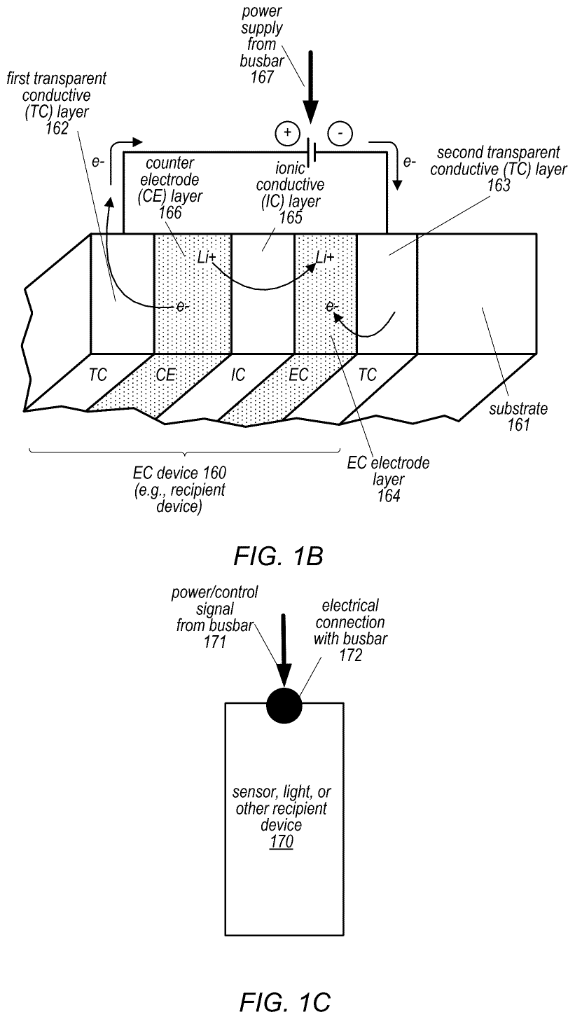

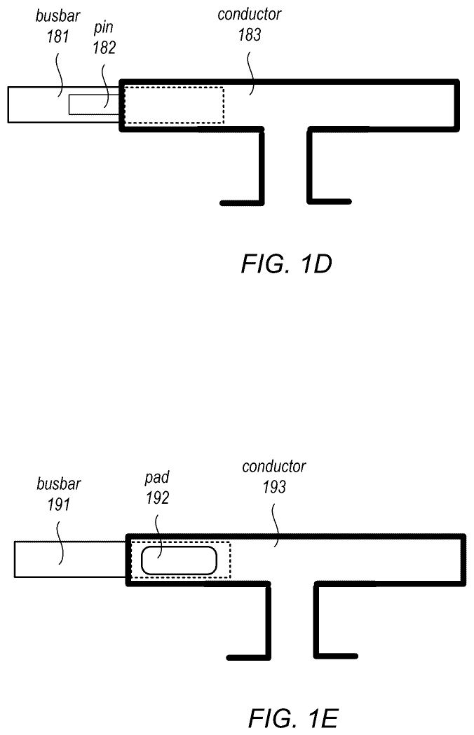

Insulated glazing units (IGUs) offer many different structures or devices with the ability to include functional components within an interior space of the glazing, affecting the transparency or other attributes that the IGUs may provide. For example, as discussed in detail below with regard to FIG. 1B, IGUs can be used to implement “smart” glass in order to change window tinting of an IGU, allowing for variations in the amount of light and heat that are passed through an IGU. For buildings and other structures that implement IGUs to act as “smart” windows, other devices too may use an IGU. For example, different appliances, including refrigeration units or other display cabinets may advantageously implement an IGU to introduce transparency for items within the device. Vehicles or other moving structures may also make use of IGUs in order to provide various transparent features.

Given the number of structures and devices which may integrate IGUs, installation challenges can occur. When multiple busbars that provide power and/or control signals to one or more recipient devices in an IGU are present, providing electrical connections to controllers for the recipient devices may be challenging to locate. For example, different buildings may have different layouts or combinations of IGUs to provide windows for spaces within the building. As there is a very large number of potential layouts for IGUs in such spaces, a technical challenge arises in minimizing the number of wires and/or choosing an efficient placement location for a controller for an IGU. Accordingly, various embodiments of conductors for connecting multiple busbars in an IGU may be implemented in order to accommodate different placement locations for a controller, busbars, and recipient devices, that may be impacted by both the design of an individual IGU and the layout of multiple IGUs that can be installed together.

Additionally, another technical challenge that arises for IGUs relates to leaks between the interior space of an IGU and the exterior of an IGU. Every penetration point of a seal of an IGU offers an additional failure point where external environmental factors, such as unwanted external air, temperatures, and unwanted particles can pass into the interior space of the IGU. Accordingly, various embodiments of conductors for connecting multiple busbars in an IGU may be implemented in order to minimize the number of penetrations of the seal of an IGU, as multiple busbars and recipient devices can be electrically connected using one conductor.

FIG. 1A illustrates an insulated glazing unit (IGU) and different views of a conductor that connects a controller to multiple busbars for one or more recipient devices in the IGU, according to some embodiments. Insulated glazing unit 110 may include multiple panes of glass or other transparent material that insulate an interior space between the multiple panes of glass oriented in parallel from an exterior space, outside the IGU 110. IGU 110 may be manufactured for installation into various fittings in structures, such as windows in buildings, or integrated in various devices or other appliances, such as glass doors in refrigeration units.

IGU 110 may offer various features that are implemented by one or more recipient devices located within the interior space of the IGU. For example, as depicted in FIG. 1A, different recipient devices 114a, an electrochromic (EC) device and/or other recipient device 114b (e.g., a sensor, light or other component) may be implemented within the interior space of IGU 110 and may receive power and/or control signals via respective busbars 112a and 112b. Busbars 112a and 112b may be of various types including, but not limited to, various metals or other conductive materials applied in different ways (e.g., screening, printing, coating, or using an electrically conductive adhesive). The combination illustrated in FIG. 1A is merely provided as an example many combinations of differing numbers and/or types of recipient devices may be implemented in other embodiments (e.g., EC device(s) only, or sensor(s)/light(s) only). As noted earlier, different design considerations may be necessitate utilizing a common location for connecting multiple busbars (e.g., 112a and 112b) to a controller which may provide the respective power and control signals used by the different recipient devices 114a and 114b in order to perform respective actions. Accordingly, a conductor may be used, such as conductor 150, to connect the busbars 112a and 112b at a common location to the controller 160.

For instance, different views, 120, 130, and 140, may be illustrated for a location indicated on IGU 110. Different locations and different arrangements or embodiments of busbars and conductors may be used in other embodiments. As noted above, the various embodiments of a conductor, such as conductor 150, may allow for many different placement options for connecting busbars. In this way, overlapping or otherwise similarly located busbars within the interior space of IGU 110, such as busbars 112a and 112b, can be connected to a controller at one location, reducing use of materials and creating flexibility in the design of IGUs for installation in different scenarios.

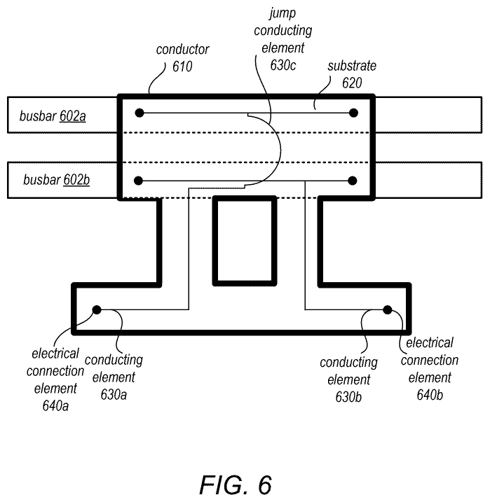

Cross section view 130 illustrates an example embodiment. Conductor 150 may be a flexible conductor, which may be implemented on a substrate, such as a carrier film, which can be shaped (e.g., bent, formed, or otherwise placed) next to an element of an IGU such as spacer 116, to reduce the usage of space by conductor 150 (e.g., to give space to run wires to a controller, as discussed below with regard to FIG. 6A. In other embodiments, a conductor may be implemented on a substrate that is stiff or otherwise sufficiently rigid so as not to be shaped or placed next to components, such as spacer 116.

Spacer 116 shown in cross section view 130 is just one example of an embodiment that creates or forms an interior space between panes 115a and 115b of IGU 110. In other embodiments, spacers may not be implemented in the vicinity of a stack in an EC device, but other components, such as various seals in and/or around layers of a stack in an EC device, may provide the interior space between panes 115a and 115b.

As shown in cross section view 130, conductor 150 penetrates a seal 113a that is between spacer 116 and pane 115a. Seal 113a and seal 113b may be separately applied, as illustrated in cross section view 130. For example, seal 113a and seal 133b may be butyl in some embodiments. Although not illustrated, in some embodiments, a secondary seal that covers spacer 116 and seals 113a and 113b (which may be considered primary seals). For example, this secondary seal may be silicone.

Conductor 150 penetrates seal 113a and is coupled to multiple busbars, such as busbars 112a and 112b. Note that in other embodiments, conductor 150 could penetrate seal 113b, just as busbars 112a and 112b could be placed near to pane 115b. Thus, the illustration is merely provided as one example embodiment. Interior view 120 provides one example embodiment of conductor 150. Various other arrangements including multiple “legs” which may be separate parallel extensions joined in an “H”, “T” or other arrangement that joins multiple legs into a single conductor. As depicted in interior view 120, busbars 112a and 112b overlap in at least one location in the interior space of IGU 110. For example, as illustrated, busbars 112a and 112b run in parallel in a same plane. Although this is depicted as the same plane as pane 115a of IGU 110, in other embodiments, busbars could run in parallel in another plane, or meet (e.g., in a corner or other location in IGU 110) in a common location at different planes (e.g., vertically in a stack) and be considered to overlap. In interior view 120, conductor 150 includes different respective conducting elements 152a and 152b. Conducting element 152a may be coupled to busbar 112a (e.g., via soldering techniques, as discussed below or using an electrically conductive adhesive).

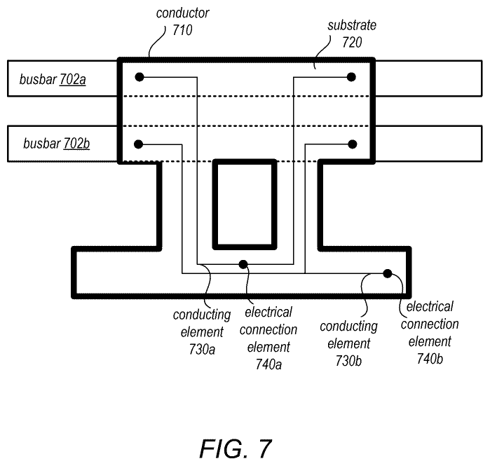

Exterior view 140 illustrates a view of conductor 150 placed next to spacer 116. On the portion of conductor 150 that remains outside of seal 113a, conducting elements 152a and 152b may be electrically coupled with a controller 160. Controller 160 may provide power and/or control signals along conducting elements 152a and 152b via busbars 112a and 112b. For example, controller 160 may be implemented using various computer system elements discussed in detail below with regard to system 700 in FIG. 7.

As noted above, recipient device 114a may be an EC device. In at least some embodiments, an EC device may be implemented as “smart” glass. Smart glass may be used to decrease heat transfer through a window and/or reduce the transmission of visible light to provide tinting or shading. A smart glass system including a smart glass (e.g., an EC device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Many smart glass units and smart glass unit systems rely on complicated and customized tint control schedules and complex three-dimensional models of buildings (e.g., to determine when there is shade and direct sun in specific locations) to control tint levels to meet desired tinting parameters of building occupants.

FIG. 1B illustrates a perspective cross-sectional view of an example EC system according to some embodiments. In this example, the EC system may include an EC device 160 secured to a substrate 161. The EC device 160 may be a non-limiting example of a smart glass or smart glass unit as provided herein. The EC device 160 may include a thin film which may be deposited on to the substrate 161. The EC device 160 may include a first transparent conductive (TC) layer 162 and a second TC layer 163 in contact with the substrate 161. In some aspects, the first TC layer 162 and the second TC layer 163 may be, or may include, one or more transparent conductive oxide (TCO) layers. The substrate 161 may include one or more optically transparent materials, e.g., glass, plastic, and the like. The EC device 160 may also include one or more active layers. For example, the EC device 160 may include a counter electrode (CE) layer 166 in contact with the first TC layer 162 and an EC electrode layer 164 in contact with the second TC layer 163. An ionic conductor (IC) layer 165 may be positioned in-between (e.g., “sandwiched” between) the CE layer 166 and the EC electrode layer 164. The EC system may include a power supply from busbar 167 which may provide regulated current or voltage to the EC device 160. Transparency of the EC device 160 may be controlled by regulating density of charges (or lithium ions) in the CE layer 166 and/or the EC electrode layer 164 of the EC device 160. For instance, when the EC system applies a positive voltage from the power supply from a busbar 167 to the first TC layer 162, lithium ions may be inserted into the EC electrode layer 164. In some aspects, when the EC system applies a positive voltage from the power supply 167 to the first TC layer 162, lithium ions may be driven across the IC layer 165 and inserted into the EC electrode layer 164. Simultaneously, charge-compensating electrons may be extracted from the CE layer 166, may flow across the external circuit, and may flow into the EC electrode layer 164. Transfer of lithium ions and associated electrons from the CE layer 166 to the EC electrode layer 164 may cause the EC device 160 to become darker—e.g., the visible light transmission of the EC device 160 may decrease. Reversing the voltage polarity may cause the lithium ions and associated charges to return to their original layer, the CE layer 166, and as a result, the EC device 160 may return to a clear state—e.g., the visible light transmission of the EC device 160 may increase.

As described herein, a smart glass or device such as the EC device 160 of FIG. 1B may receive a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass.

As discussed above, other devices in addition to or instead of EC devices may be implemented within an IGU 110. These other recipient devices may cover a wide range of sensors, lights, or other components that provide different functions. FIG. 1C illustrates an example recipient device that receives power and/or control signals from a busbar, according to some embodiments. Sensor, light or other recipient device may implement an electrical connection with busbar 172. For example, a direct connection, such as soldering pad or pin may be soldered on device 170. In at least one embodiment, solder or flux may be pre-applied to a pin. In other embodiments, one or more wires may provide the electrical connection 172 with the busbar (which may be soldered or electrically adhered to a busbar). As illustrated at 171 power or control signal may be received from a busbar. In some embodiments, multiple busbars may be connected electrically with device 170 to provide both power and a control signal.

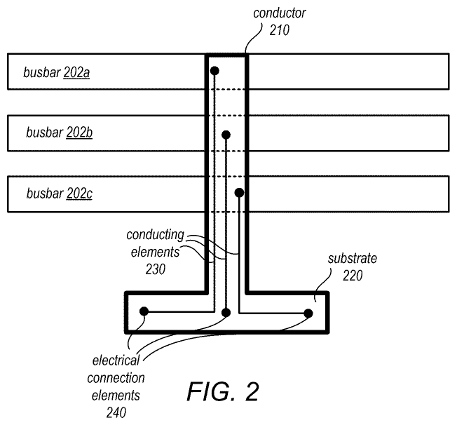

As discussed above with regard to FIG. 1A, different arrangements of a conductor may be implemented. FIGS. 2-5 and the following discussion illustrate merely some of the possible arrangements of conducting elements of one or more legs of a conductor. Conductors may include a substrate that may be rigid or flexible in order to place the conductor in a desired position (e.g., along a spacer as illustrated in cross section view 130 in FIG. 1A). A substrate for the conductor may, in some embodiments, be implemented using non-conductive material on which conductive elements (e.g., various metals or other conductive substances) are deposited, adhered, or otherwise connected to the substrate in order to provide separate electrical paths for power or control signals, as desired in different embodiments, according to the number and arrangements of recipient devices and busbars. In at least some embodiments, a film or other coating may be placed over the conducting elements and substrate to with only electrical connection elements exposed for making connections to a controller directly or indirectly, as discussed below with regard to FIGS. 6A and 6B, and with busbars. For example, the electrical connection elements may include soldering pins, soldering pads, or other elements that can be soldered to join a conducting element of a conductor with a busbar or controller. In the case of soldering pins, the pins may protrude out further from a conductor's substrate. Therefore, in the illustrations of various embodiments of conductor that follow, electrical connection elements may be a protruding pin or a pad.

In some embodiments, pins may be conductive metal (e.g., cylindrical or flat) that protrude from the conductor. The exposed surface of the pins can be soldered to busbars, similar to pads, where solder may be melted, deposited, and the pin and busbar joined using the deposited solder. For example, in FIG. 1D, conductor 183 illustrates a pin 182 that protrudes from conductor 183 as the electrical connection element at which solder may be deposited to join the conductor with the busbar 181.

In some embodiments, pads may be flat, conductive surfaces that are located on a surface of the conductor (e.g., an exposed portion of conducting elements). Pads may be used to make electrical connections between the conductor and the busbar (or controller). Pads may be made of a conductive material, such as a conductive metal like copper, and deposits of solder (e.g., a metal/metal alloy that can be melted and deposited on surfaces of two components to be electrically connected, such as the pad of the connector and the busbar). For example, in FIG. 1E, conductor 193 illustrates a pad 192 as the electrical connection element at which solder may be deposited to join the conductor with the busbar 191.

In some embodiments, the electrical connection elements may be an exposed portion of the conducting element which can be adhered to a busbar or controller using an electrically conductive adhesive. Just as conductors can be arranged in various ways (e.g., varying number of legs and conducting elements), different types of electrical connection elements discussed above can be used in varying numbers and combinations in different embodiments. In at least some embodiments, the conductor may be considered a flat conductor with a thickness of the conductor less than half a thickness of a seal that the conductor penetrates to reach busbars in the interior of an IGU.

FIG. 2 illustrates an example conductor with a single leg connected to multiple busbars, according to some embodiments. In FIG. 2, multiple busbars 202a, 202b, and 202c, are illustrated. Note that other numbers or arrangements where multiple busbars meet can be implemented in other embodiments. In the illustrated example, conductor 210 with substrate 220 includes a single leg on which different respective conducting elements 230 run which provide separate power or control signals to each busbar 202a, 202b, and 202c. Although the leg of conductor 210 overlaid multiple busbars 202a, 202b, and 202c, only one electrical conducting element using one respective electrical connection element is implemented for each busbar in the illustrated arrangement. Other arrangements may be made in other embodiments.

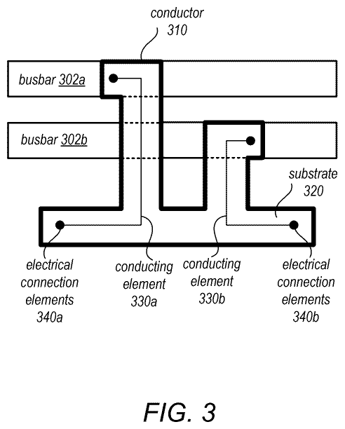

FIG. 3 illustrates an example conductor with multiple legs connected to individual busbars, according to some embodiments. Conductor 310 may be implemented using the various elements discussed above with regard to FIGS. 1A-2, including substrate 320 and respective electrical conducting elements 330a and 330b, and electrical connection elements 340a and 340b. In the illustrated example of FIG. 3, different legs are connected to different busbars. For example, one leg carries conducting element 330a to connect to busbar 302a. Likewise, another leg carries conducting element 330b to connect to busbar 302b.

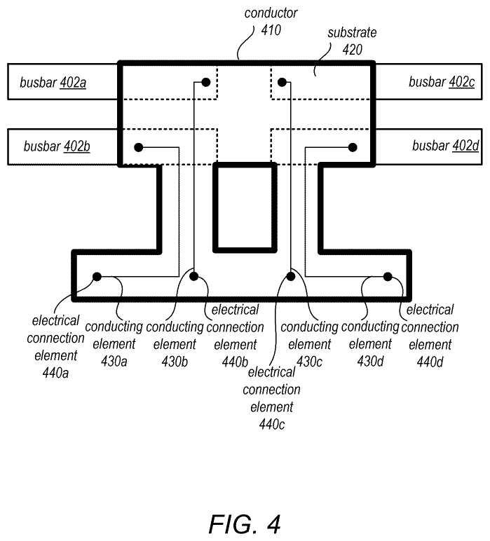

FIG. 4 illustrates an example conductor with multiple legs connected to multiple busbars, according to some embodiments. Conductor 410 may be implemented using the various elements discussed above with regard to FIGS. 1A-3, including substrate 420 and respective electrical conducting elements 430a, 430b, 430c, and 430d and electrical connection elements 440a, 440b, 440c, and 440d. In the illustrated example of FIG. 4, different legs are connected to different busbars. For example, one leg carries conducting element 430a to connect to busbar 402b and conducting element 430b to connect to busbar 402a. Likewise, another leg carries conducting element 430c to connect to busbar 402c and conducting element 430d to connect to busbar 402b. In this illustrated example, four busbars meet in one common location, with different pairs of busbars overlapping in a plane (e.g., busbar 402a and 402b overlapping and busbars 402c and 402d overlapping).

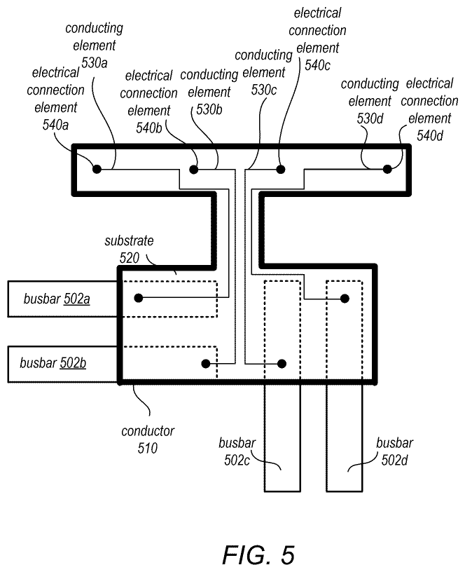

FIG. 5 illustrates an example conductor with a one leg connected to multiple busbars that meet, according to some embodiments. Conductor 510 may be implemented using the various elements discussed above with regard to FIGS. 1A-4, including substrate 520 and respective electrical conducting elements 530a, 530b, 530c, and 530d and electrical connection elements 540a, 540b, 540c, and 540d. In the illustrated example of FIG. 5, one leg is connected to different busbars, some of which do not overlap or do not run in parallel. For example, one leg carries conducting element 530a to connect to busbar 502a, conducting element 530b to connect to busbar 502b, conducting element 530c to connect to busbar 502c, and conducting element 530d to connect to busbar 502d. In this illustrated example, four busbars meet in one common location, with different pairs of busbars overlapping in a plane (e.g., busbar 502a and 502b overlapping and busbars 502c and 502d overlapping) and intersecting along a common path (e.g., busbars 502a and 520b intersect the paths of busbars 502c and 502d, although they do not make contact).

FIG. 6 illustrates an example conductor with multiple legs connected to individual busbars using a jump connection, according to some embodiments. Conductor 610 may be implemented using the various elements discussed above with regard to FIGS. 1A-2, including substrate 620 and respective electrical conducting elements 630a and 630b, and electrical connection elements 640a and 640b. In the illustrated example of FIG. 3, different legs are connected to different busbars. For example, one leg carries conducting element 630a to connect to busbar 602a As part of this connection, jump conducting element 630c may be used to leap frog otherwise provide a connection that passes over conducting element 630b without interfering with power or control signals conveyed through conducting element 630b. Likewise, another leg carries conducting element 630b to connect to busbar 602b.

FIG. 7 illustrates an example conductor with multiple legs connected to individual busbars using spaced connections, according to some embodiments. Conductor 710 may be implemented using the various elements discussed above with regard to FIGS. 1A-2, including substrate 720 and respective electrical conducting elements 730a and 730b, and electrical connection elements 740a and 740b. In the illustrated example of FIG. 3, both legs are connected to both busbars. For example, one leg carries conducting element 730a to connect to busbar 702a and conducting element 730b to busbar 702b. Likewise, another leg carries conducting element 730b to connect to busbar 702b and conducting element 730a to connect to busbar 702a. As each leg may carries separate conducting elements to different busbars, spacing between conducting elements 730a and 730b may be maintained.

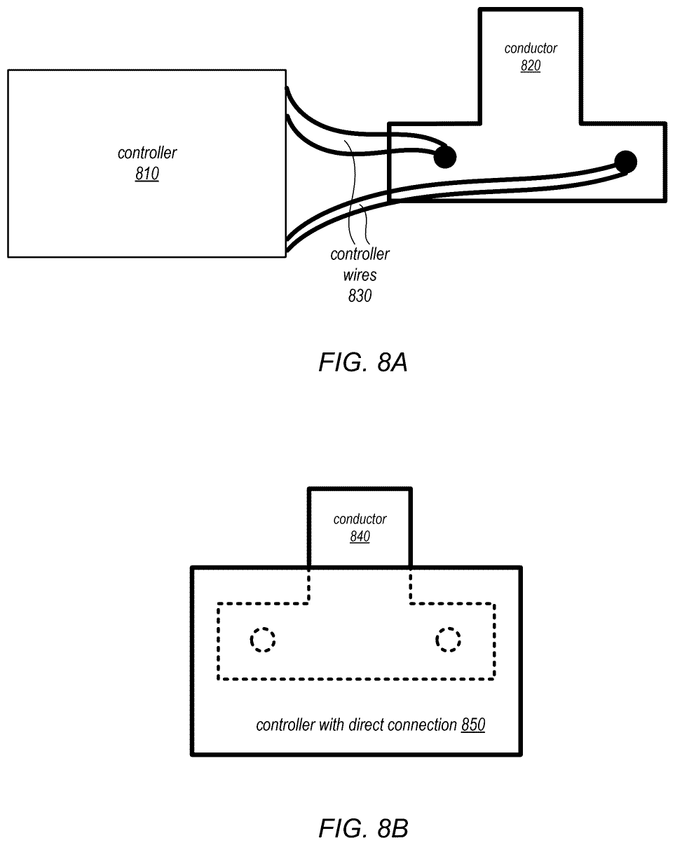

FIGS. 8A and 8B illustrate different types of connections between controllers for recipient devices in an IGU with a conductor, according to some embodiments. FIG. 8A illustrates an indirect connection between conductor 820 and controller 810. Conductor 820 may be similar to various example embodiments of conductors discussed above with regard to FIGS. 1A-5. In this example, controller 810 includes one or more wires to provide respective power or control signals along each connected conducting element. In the illustrated example, pairs of wires are connected to each connection element of conductor 820. Use of controller wires 830 allows for controller 810 to be placed at some desirable distance or location from the IGU.

FIG. 8B illustrates a direct connection between conductor 820 and controller 850. Conductor 840 may be similar to various example embodiments of conductors discussed above with regard to FIGS. 1A-5. In this example, controller 850 includes one or more connection elements (e.g., soldering elements, such as pads, or electrically conductive adhesive) that can be electrically connected directly to one or more corresponding connection elements of conductor 840 (e.g., soldering elements, such as pads, or electrically conductive adhesive). Use of direct connection eliminates the need for extra wiring, which can complicate installation of an IGU in other structures or devices. Instead, controller 850 can be located directly next to the conductor 840 at the location from which it protrudes from the IGU.

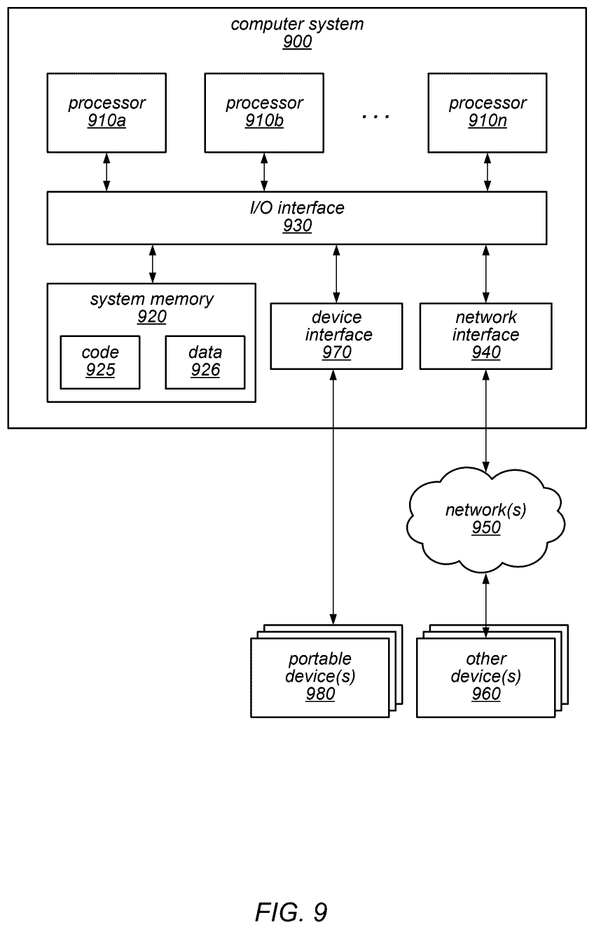

FIG. 9 is a block diagram illustrating a computer system 900 according to some aspects, as well as various other systems, components, services, or devices described herein. The computer system 900, for example, may be included in the controller and/or system controllers described herein with respect to FIGS. 1A-8B. For example, computer system 900 may implement a control unit configured to implement and/or utilize the features, methods, mechanisms and/or techniques described herein, in different embodiments. Computer system 900 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 900 includes one or more processors 910 (any of which may include multiple cores, which may be single or multi-threaded) coupled to a system memory 920 via an input/output (I/O) interface 930. Computer system 900 further includes a network interface 940 coupled to I/O interface 930. In various embodiments, computer system 900 may be a uniprocessor system including one processor 910, or a multiprocessor system including several processors 910 (e.g., two, four, eight, or another suitable number). Processors 910 may be any suitable processors capable of executing instructions. For example, in various embodiments, processors 910 may be general-purpose or embedded processors implementing any of a variety of instruction set architectures (ISAs), such as the x86, PowerPC, SPARC, or MIPS ISAs, or any other suitable ISA. In multiprocessor systems, each of processors 910 may commonly, but not necessarily, implement the same ISA. The computer system 900 also includes one or more network communication devices (e.g., network interface 940) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote-control device (e.g., a remote control), a wall mounted (e.g., hard wired) device, or an application executing on any of various types of devices (e.g., a portable phone, smart phone, tablet and/or desktop computer are just a few examples). In some embodiments, control unit may monitor sensor signals received measured by and received from a sensor or adjust lighting other recipient device operations in response to user requests.

In the illustrated embodiment, computer system 900 is coupled to one or more portable devices 980 via device interface 970. In various embodiments, portable device(s) 980 may correspond to disk drives, tape drives, solid state memory, other storage devices, or any other persistent storage device. Computer system 900 (or a distributed application or operating system operating thereon) may store instructions and/or data in portable device(s) 980, as desired, and may retrieve the stored instruction and/or data as needed. In some embodiments, portable device(s) 980 may store information regarding one or more EC devices, such as information regarding design parameters, etc. usable by a controller when changing tint levels using the techniques described herein.

Computer system 900 includes one or more system memories 920 that can store instructions 925 and data 926 accessible by processor(s) 910. In various embodiments, system memories 920 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 920 may contain program instructions 925 that are executable by processor(s) 910 to implement the methods and techniques described herein. In various embodiments, program instructions 925 may be encoded in platform native binary, any interpreted language such as Java™ bytecode, or in any other language such as C/C++, Java™, etc., or in any combination thereof. For example, in the illustrated embodiment, program instructions 925 include program instructions executable to implement the functionality of a control unit, a stack voltage measurement module, an electron spin resonance (ESR) module, an open circuit voltage (OCV) module, a supervisory control system, local controller, project database, etc., in different embodiments. In some embodiments, program instructions 925 may implement a control unit configured to implement and/or utilize the features, methods, mechanisms and/or techniques described herein, and/or other components.

In some embodiments, program instructions 925 may include instructions executable to implement an operating system (not shown), which may be any of various operating systems, such as UNIX, LINUX, Solaris™, MacOS™, Windows™, etc. Any or all of program instructions 925 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 900 via I/O interface 930. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 900 as system memory 920 or another type of memory. In other embodiments, program instructions may be communicated using optical, acoustical, or other form of propagated signal (e.g., carrier waves, infrared signals, digital signals, etc.) conveyed via a communication medium such as a network and/or a wireless link, such as may be implemented via network interface 940.

In one embodiment, I/O interface 930 may coordinate I/O traffic between processor 910, system memory 920 and any peripheral devices in the system, including through network interface 940 or other peripheral interfaces, such as device interface 970. In some aspects, the network interface 940 and/or the device interface 970 may include a transceiver to wirelessly communicate with the other devices 960 and/or the portable devices 980. In some embodiments, I/O interface 930 may perform any necessary protocol, timing, or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments, some or all of the functionality of I/O interface 930, such as an interface to system memory 920, may be incorporated directly into processor 910.

Network interface 940 may allow data to be exchanged between computer system 900 and other devices attached to a network, such as other computer systems 960. In addition, network interface 940 may allow communication between computer system 900 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 900. Multiple input/output devices may be present in computer system 900 or may be distributed on various nodes of a distributed system that includes computer system 900. In some embodiments, similar input/output devices may be separate from computer system 900 and may interact with one or more nodes of a distributed system that includes computer system 900 through a wired or wireless connection, such as over network interface 940. Network interface 940 may commonly support one or more wireless networking protocols (e.g., Wi-Fi/IEEE 802.11, or another wireless networking standard). However, in various embodiments, network interface 940 may support communication via any suitable wired or wireless general data networks, such as other types of Ethernet networks, for example. Additionally, network interface 940 may support communication via telecommunications/telephony networks such as analog voice networks or digital fiber communications networks, via storage area networks such as Fibre Channel SANs, or via any other suitable type of network and/or protocol. In various embodiments, computer system 900 may include more, fewer, or different components than those illustrated in FIG. 9 (e.g., displays, video cards, audio cards, peripheral devices, other network interfaces such as an ATM interface, an Ethernet interface, a Frame Relay interface, etc.)

Embodiments of the present disclosure can be described in view of the following clauses:
Clause 1. An insulated glazing unit (IGU), comprising:
a first pane, a second pane, and one or more seals, wherein the first pane and the second pane run parallel to one another, and wherein the one or more seals form a glazing interior space with the first pane and the second pane;
wherein the glazing interior space comprises one or more recipient devices and a plurality of busbars, wherein each of the plurality of busbars is coupled to at least one of the one or more recipient devices;
a conductor, comprising a plurality of conducting elements, wherein each of the conducting elements is respectively electrically connected to different ones of the plurality of busbars providing respective ones of at least one of power and control signal received from a controller for one or more recipient devices, wherein the conductor penetrates at least one of the one or more seals at a location where at least two of the plurality of busbars are available for connection.
Clause 2. The IGU of clause 1, wherein the conductor is directly connected to the controller in an exterior space with respect to the IGU.
Clause 3. The IGU of clause 1, wherein the conductor is connected via one or more wires to the controller in an exterior space with respect to the IGU.
Clause 4. The IGU of clause 1, wherein the conductor comprises two or more legs that respectively include two or more of the plurality of conducting elements and penetrate the at least one seal of the one or more seals.
Clause 5. The IGU of clause 1, wherein the conductor comprises two or more legs that respectively include a single one of the plurality of conducting elements and penetrate the at least one seal of the one or more seals.
Clause 6. The IGU of clause 1, wherein the conductor comprises a single leg that includes the plurality of conducting elements and penetrates the at least one seal of the one or more seals.
Clause 7. The IGU of clause 1, wherein at least one of the one or more recipient devices is an electrochromic device.
Clause 8. The IGU of clause 1, wherein at least one of the conducting elements is soldered to one of the plurality of busbars using a pin.
Clause 9. The IGU of clause 1, wherein at least one of the conducting elements is respectively soldered to one of the plurality of busbars using a pad.
Clause 10. The IGU of clause 1, further comprising a spacer with two pane contact surfaces that run parallel to one another, wherein a first pane contact surface is connected with the first pane and a second pane contact surface is connected with the second pane, wherein the first pane contact surface and the second contact pane surface are connected via the one or more seals.
Clause 11. The IGU of clause 10, wherein the conductor is a flexible conductor that is placed next to another surface of the spacer that does not contact the first pane or the second pane.
Clause 12. A conductor for an insulated glazing unit (IGU), wherein the conductor comprises:
a plurality of conducting elements, wherein each of the conducting elements is capable of being electrically connected to different ones of plurality of busbars in an interior space of the IGU, wherein each of the conducting elements provides different respective ones of at least one of power and control signal received from a controller connected to the conductor to one or more recipient devices in the interior space of the IGU via the plurality of busbars, wherein the plurality of conducting elements are arranged in one or more legs to reach two or more of the plurality of busbars available for connection at a location in the interior space of the IGU.
Clause 13. The conductor of clause 12, wherein at least one of the plurality of conducting elements comprises a soldering element that is a pin used to electrically connect to one of the plurality of busbars.
Clause 14. The conductor of clause 12, wherein at least one of the plurality of conducting elements comprises a soldering element that is a pad used to electrically connect to one of the plurality of busbars.
Clause 15. The conductor of clause 12, wherein the one or more legs comprise two or more legs that respectively include two or more of the plurality of conducting elements.
Clause 16. The conductor of clause 12, wherein the one or more legs comprise two or more legs that respectively include a single one of the plurality of conducting elements.
Clause 17. The conductor of clause 12, wherein the one or more legs is a single leg.
Clause 18. The conductor of clause 12, wherein the conductor is a flexible conductor that is placed next to a surface of a spacer in the IGU.
Clause 19. The conductor of clause 12, wherein the conductor is a flat conductor with a thickness less than half of at one seal of the one or more seals of the IGU, wherein the one or more legs penetrate the at least one seal to reach the two or more of the plurality of busbars.
Clause 20. The conductor of clause 12, wherein the conductor is directly connected to the controller in an exterior space with respect to the IGU.

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. An insulated glazing unit (IGU), comprising:
a first pane, a second pane, and one or more seals, wherein the first pane and the second pane run parallel to one another, and wherein the one or more seals form a glazing interior space with the first pane and the second pane;
wherein the glazing interior space comprises one or more recipient devices and a plurality of busbars, wherein each of the plurality of busbars is coupled to at least one of the one or more recipient devices;
a conductor, comprising a plurality of conducting elements, wherein each of the conducting elements is respectively electrically connected to different ones of the plurality of busbars providing respective ones of at least one of power and control signal received from a controller for one or more recipient devices, wherein the conductor penetrates at least one of the one or more seals at a location where at least two of the plurality of busbars are available for connection.

2. The IGU of claim 1, wherein the conductor is directly connected to the controller in an exterior space with respect to the IGU.

3. The IGU of claim 1, wherein the conductor is connected via one or more wires to the controller in an exterior space with respect to the IGU.

4. The IGU of claim 1, wherein the conductor comprises two or more legs that respectively include two or more of the plurality of conducting elements and penetrate the at least one seal of the one or more seals.

5. The IGU of claim 1, wherein the conductor comprises two or more legs that respectively include a single one of the plurality of conducting elements and penetrate the at least one seal of the one or more seals.

6. The IGU of claim 1, wherein the conductor comprises a single leg that includes the plurality of conducting elements and penetrates the at least one seal of the one or more seals.

7. The IGU of claim 1, wherein at least one of the one or more recipient devices is an electrochromic device.

8. The IGU of claim 1, wherein at least one of the conducting elements is soldered to one of the plurality of busbars using a pin.

9. The IGU of claim 1, wherein at least one of the conducting elements is respectively soldered to one of the plurality of busbars using a pad.

10. The IGU of claim 1, further comprising a spacer with two pane contact surfaces that run parallel to one another, wherein a first pane contact surface is connected with the first pane and a second pane contact surface is connected with the second pane, wherein the first pane contact surface and the second contact pane surface are connected via the one or more seals.

11. The IGU of claim 10, wherein the conductor is a flexible conductor that is placed next to another surface of the spacer that does not contact the first pane or the second pane.

12. A conductor for an insulated glazing unit (IGU), wherein the conductor comprises:
a plurality of conducting elements, wherein each of the conducting elements is capable of being electrically connected to different ones of plurality of busbars in an interior space of the IGU, wherein each of the conducting elements provides different respective ones of at least one of power and control signal received from a controller connected to the conductor to one or more recipient devices in the interior space of the IGU via the plurality of busbars, wherein the plurality of conducting elements are arranged in one or more legs to reach two or more of the plurality of busbars available for connection at a location in the interior space of the IGU.

13. The conductor of claim 12, wherein at least one of the plurality of conducting elements comprises a soldering element that is a pin used to electrically connect to one of the plurality of busbars.

14. The conductor of claim 12, wherein at least one of the plurality of conducting elements comprises a soldering element that is a pad used to electrically connect to one of the plurality of busbars.

15. The conductor of claim 12, wherein the one or more legs comprise two or more legs that respectively include two or more of the plurality of conducting elements.

16. The conductor of claim 12, wherein the one or more legs comprise two or more legs that respectively include a single one of the plurality of conducting elements.

17. The conductor of claim 12, wherein the one or more legs is a single leg.

18. The conductor of claim 12, wherein the conductor is a flexible conductor that is placed next to a surface of a spacer in the IGU.

19. The conductor of claim 12, wherein the conductor is a flat conductor with a thickness less than half of at one seal of the one or more seals of the IGU, wherein the one or more legs penetrate the at least one seal to reach the two or more of the plurality of busbars.

20. The conductor of claim 12, wherein the conductor is directly connected to the controller in an exterior space with respect to the IGU.
